(19) United States
(12) Patent Application Publication
(10) Pub. No.: US 2012/0056869 A1
(43) Pub. Date: Mar. 8, 2012

(54) ORGANIC LIGHT EMITTING DIODE DRIVER

(75) Inventors: Sang Hyun CHA, Seoul (KR); Youn Joong LEE, Seoul (KR); Gyu Hyeong CHO, Daejeon (KR); Jin Yong JEON, Daegu (KR); Jun Hyeok YANG, Daegu (KR); Hyun Sik KIM, Jeollabuk-do (KR); Jae Shin LEE, Gyunggi-do (KR)

(73) Assignees: KOREA ADVANCED INSTITUTE OF SCIENCE AND TECHNOLOGY, Daejeon (KR); SAMSUNG ELECTRO-MECHANICS CO., LTD., Gyunggi-do (KR)

(21) Appl. No.: 13/093,986

(22) Filed: Apr. 26, 2011

(30) Foreign Application Priority Data
Sep. 6, 2010 (KR) 10-2010-0087078

(51) Int. Cl. G09G 3/12; G09G 3/30

(52) U.S. Cl. 345/214; 345/76

(57) ABSTRACT

There is provided an organic light emitting diode driver capable of compensating for pixel deterioration in real time during the driving of pixels by selectively compensating pixels, requiring compensation, for the deterioration thereof. The organic light emitting diode driver includes: a converter converting input data into compensation data used to selectively compensate for pixel deterioration according to whether or no the input data has been calibrated; a driver driving pixels of a pixel unit according to the compensation data from the converter; and a compensator providing the converter with a deterioration compensation signal according to deterioration information obtained from a pixel driven by the driver.

### CROSS-REFERENCE TO RELATED APPLICATIONS

This application claims the priority of Korean Patent Application No. 10-2010-0087073 filed on Sep. 6, 2010, in the Korean Intellectual Property Office, the disclosure of which is incorporated herein by reference.

### BACKGROUND OF THE INVENTION

1. Field of the Invention

The present invention relates to an organic light emitting diode driver, and more particularly, to an organic light emitting diode driver capable of compensating for pixel deterioration according to whether or not a target pixel to be driven by input data is calibrated and according to the results of comparing the input data with data included in a preset test signal.

2. Description of the Related Art

Currently, in accordance with increasing demand for display devices achieving a reduction in volume while having a large size, universal displays such as cathode ray tube (CRT) displays or liquid crystal displays (LCDs) are being replaced with display devices employing organic light emitting diodes (OLEDs). When compared to existing LCDs, display devices employing OLEDs have an image quality reaction speed which is significantly more rapid, and a thickness and a weight which are reduced by approximately one third, and have therefore come to prominence.

This OLED display is divided into a passive matrix organic light emitting diode (PMOLED) display and an active matrix organic light emitting diode (AMOLED) display according to a driving scheme. In particular, an AMOLED display capable of individually controlling pixels, which are the smallest elements of an image, is generally used.

Such an AMOLED display is superior in terms of image quality, thickness, weight, brightness, power consumption, and the like, as compared to existing LCDs.

However, the AMOLED display may suffer from deterioration, deterioration being defined as the generation of an image having gradually lower luminance in response to the same data signal over time, and this may result in a failure to display an image having uniform luminance.

### SUMMARY OF THE INVENTION

An aspect of the present invention provides an organic light emitting diode driver capable of compensating for pixel deterioration according to whether or not a target pixel to be driven by input data is calibrated and according to the results of comparing the input data with data included in a preset test signal.

According to an aspect of the present invention, there is provided an organic light emitting diode driver including: a converter converting input data into compensation data used to selectively compensate for pixel deterioration according to whether or not the input data has been calibrated and according to a result of comparing the input data with a test signal having preset test data; a test signal generator providing the test signal; a driver driving pixels of a pixel unit according to the compensation data from the converter; and a compensator providing the converter with a deterioration compensation signal according to deterioration information obtained from a pixel driven by the driver.

The converter may store calibration data included in the deterioration compensation signal from the compensator and convert input data for a non-calibrated pixel into calibration data corresponding thereto. The converter may convert input data for a calibrated pixel into compensation data corresponding thereto when the input data for a calibrated pixel is identical to the test data. The converter may convert input data for a calibrated pixel into compensation data corresponding to the test signal when the input data for a calibrated pixel is different from the test data and the pixel to be driven by the input data for a calibrated pixel is to be compensated for. The converter may output initial data, stored at an operation start time and corresponding to input data for a calibrated pixel, when the input data for a calibrated pixel is different from the test data and the pixel to be driven by the input data for a calibrated pixel is not to be compensated for.

The converter may include a compensation selector selecting whether to perform compensation according to whether or not the input data has been calibrated; a selection signal generator generating a selection signal selecting compensation data whether or not the test signal is identical to the input data selected to be compensated for by the compensation selector; a calibration data storing memory storing the calibration data corresponding to the input data and outputting the calibration data when the input data is determined as input data for a non-calibrated pixel; and a compensation data generator providing the compensation data corresponding to the input data or the test data according to the selection signal of the selection signal generator.

The calibration data storing memory may further store the initial data storing luminance data of each pixel at the operation start time.

The selection signal generator may include a comparator comparing whether or not the test signal is identical to the input data for a calibrated pixel selected to be compensated for by the compensation selector; a selection signal generator generating the selection signal according to the comparison result from the comparator and a compensation history of the input data for a calibrated pixel; and a compensation history storing memory storing the compensation history of the input data for a calibrated pixel.

The compensation data generator may have a plurality of preset gray scale ranges, and may provide the compensation data as a representative value of a gray scale range, to which a gray scale level of the input data belongs.

The compensator may include a previous data storing memory storing initial luminance data of a target pixel to be compensated or luminance data obtained by a previous compensation; a deterioration calculator calculating a degree of deterioration in the pixel by comparing deterioration information of the pixel with the luminance data from the previous data storing memory; and a calibration data calculator calculating calibration, data adjusting a luminance of the pixel according to the degree of deterioration calculated by the deterioration calculator, or the compensator may include a previous data storing memory storing initial luminance data and use time of a target pixel to be compensated or luminance data and use time thereof obtained by a previous compensation; a deterioration calculator calculating a degree of deterioration in the pixel by comparing deterioration information of the pixel with the luminance data and the use time thereof from the previous data storing memory; and a calibration data calculator calculating calibration data adjusting a luminance of the pixel according to the degree of deterioration calculated by the deterioration calculator.

The calibration data calculator may calculate the calibration data adjusting the luminance of the pixel to have a luminance equal to an average luminance of all of the pixels.

The organic light emitting diode driver may further include an analog-to-digital converter (ADC) converting the deterioration information obtained from the driven pixel of the pixel unit into a digital deterioration sensing signal and transferring the digital deterioration sensing signal to the compensator.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a view schematically showing the configuration of an organic light emitting diode driver according to an exemplary embodiment of the present invention;

FIG. 2 is a view schematically showing the configuration of a converter used in an organic light emitting diode driver according to an exemplary embodiment of the present invention;

FIG. 3 is a view showing representative value ranges of a compensation data generator used in the converter of FIG. 2;

FIG. 4 is a view schematically showing the configuration of a selection signal generator used in the converter of FIG. 2;

FIG. 5 is a view schematically showing the configuration of a compensator used in an organic light emitting diode driver according to an exemplary embodiment of the present invention; and

FIG. 6 is a flowchart showing the operations of an organic light emitting diode driver according to an exemplary embodiment of the present invention.

### DETAILED DESCRIPTION OF THE PREFERRED EMBODIMENT

Exemplary embodiments of the present invention will now be described in detail with reference to the accompanying drawings.

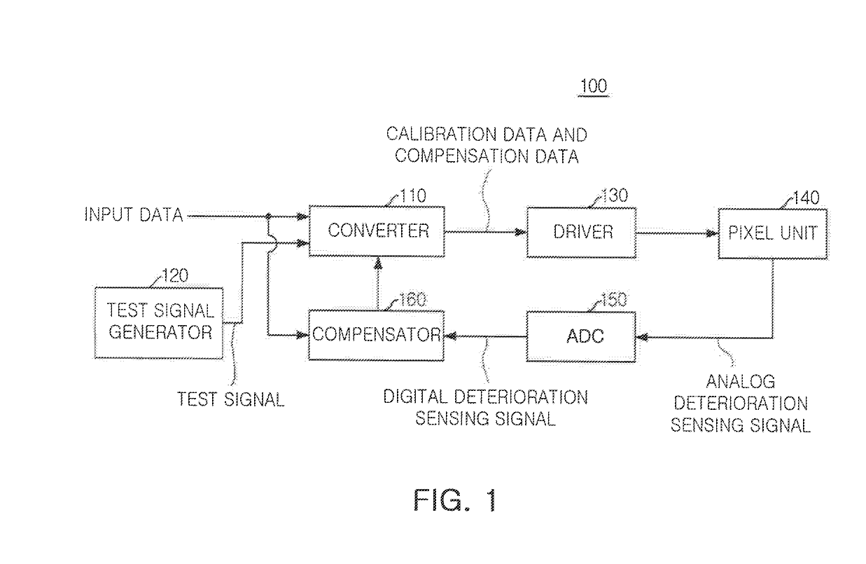

FIG. 1 is a view schematically showing the configuration of an organic light emitting diode driver according to an exemplary embodiment of the present invention.

Referring to FIG. 1, an organic light emitting diode driver 100 may include a converter 110, a test signal generator 10, a driver 130, pixel unit 140, an analog-to-digital converter (ADC) 150, and a compensator 160.

The converter 110 may receive input data used to drive a pixel and a test signal having preset data therein. The input data may include a gray scale in order to drive a pixel corresponding thereto. The converter 110 may convert the input data into calibration data, in which deterioration has been compensated for, or may convert the input data or the test signal into compensation data, which is used to compensate for deterioration, according to whether or not the input data is calibrated and whether or not the input data is identical to the test signal.

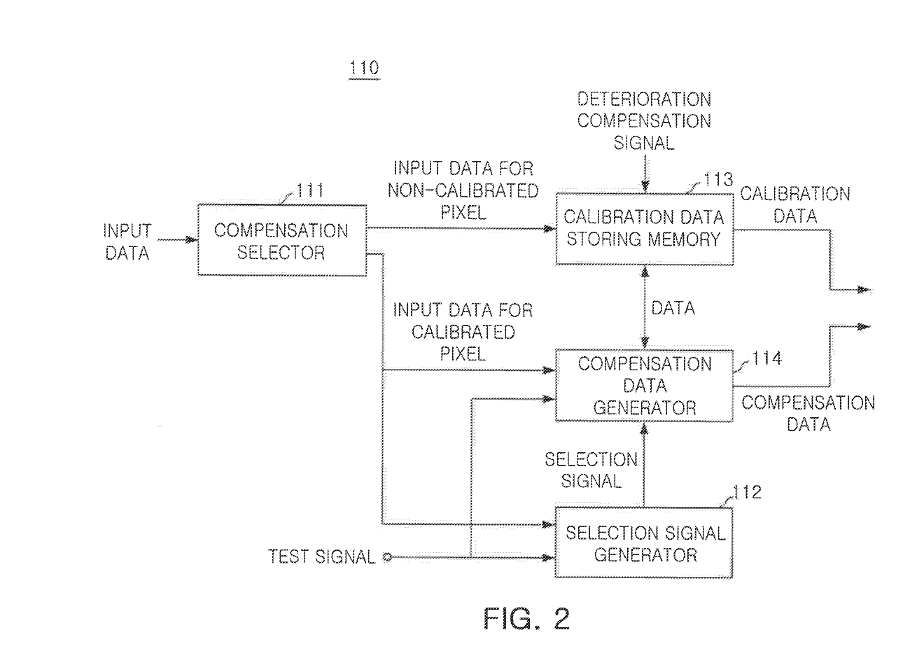

FIG. 2 is a view schematically showing the configuration of a converter used in an organic light emitting diode according to an exemplary embodiment of the present invention.

Referring to FIGS. 1 and 2, the converter 110 used in the organic light emitting diode driver 100 according to the exemplary embodiment of the present invention may include a compensation selector 111, a selection signal generator 112, a calibration data storing memory 113 and a compensation data generator 114.

The compensation selector 111 may determine whether or not the compensation of the input data has been performed according to whether calibration data corresponding to a target pixel to be driven by the input data is present or not. Accordingly, the input data may be divided into input data for a non-calibrated pixel and input data for a calibrated pixel according to the selection of the compensation selector 111.

The selection signal generator 112 may generate a selection signal for generating compensation data corresponding to the input data for a calibrated pixel or the test signal according to whether or not the input data for calibrated pixels is identical to the test signal, and may generate a selection signal for displaying initial data, stored at an operation start time, on a screen according to compensation history.

When the input data is determined as input data for a non-calibrated pixel according to the results of the determination of the compensation selector 111, the calibration data storing memory 113 provides the driver 130 with calibration data, obtained in a deterioration compensation signal of the compensator 160. At this time, the calibration data storing memory 113 may have initial data that is identical to the input data or data that corresponds to the initial data stored therein at the operation start time. That is, since no deterioration may occur at the operation start time, the initial data that is identical to the input data or the data that corresponds to the initial data may be stored in the calibration data storing memory 113.

Meanwhile, when the input data is determined as input data for a calibrated pixel according to the results of the determination of the compensation selector 111, the compensation data generator 114 provides the driver 130 with compensation data. At this time, the compensation data generator 114 may convert the input data for a calibrated pixel or the test signal into the compensation data according to the selection signals of the selection signal generator 112. That is, the compensation data generator 114 may cause the pixel to be driven with compensation data having an amount of bits different from that of the input data for calibrated pixels or the test signal. For example, when the input data is 8 bit data of ‘01001100’, the compensation data may be used to add 2 bits thereto and convert the 8-bit data into 10-bit data. At this time, the added 2 bits may be a most significant bit (MSB) and a least significant bit (LSB). Accordingly, the 10-bit compensation data may be ‘x01001100x’. The LSB may be adopted in order to increase the resolution of a target pixel which is to be compensated for its deterioration, and the MSB may be adopted in order to prevent overflow which may occur when the amount of bits of the data is changed to be increased during the deterioration compensation.

In addition, the initial data that is identical to the input data or the data that corresponds to the initial data may be 8-bit data or may be 10-bit data similar to the compensation data.

Meanwhile, the compensation data generator 114 may generate the compensation data as a representative value of a preset gray scale range according to the gray scale level of the input data when it converts the input data for calibrated pixels or the test signal into the compensation data.

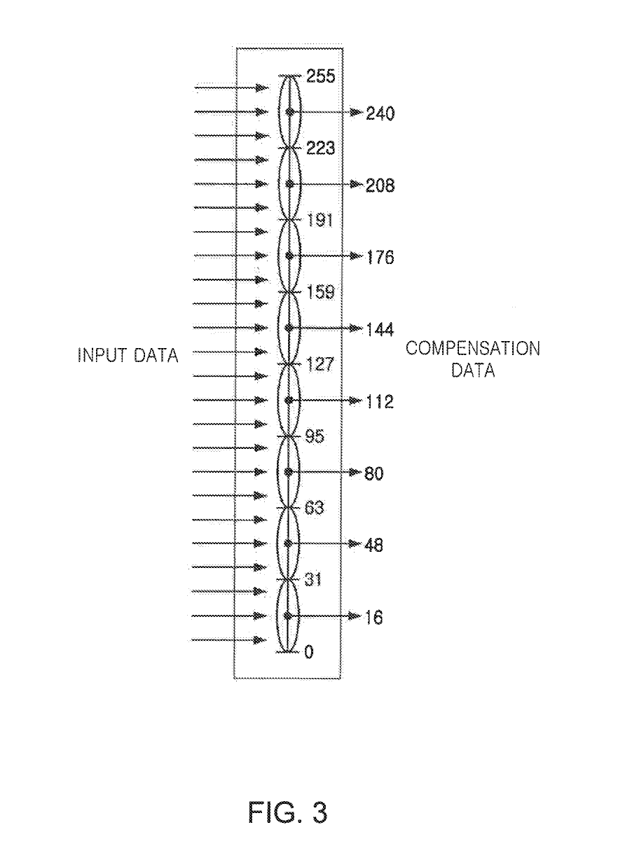

FIG. 3 is a view showing representative value ranges of a compensation data generator used in the converter of FIG. 2.

Referring to FIGS. 1 to 3, the compensation data generator 113 may have a gray scale range having preset levels. A plurality of gray scale ranges may be provided. When the gray scale level of the input data for a calibrated pixel or the test signal belongs to one of the plurality of gray scale ranges, the compensation data generator 113 may generate the compensation data as a representative value in the corresponding gray scale range. For example, in a case in which the compensation data generator 113 has eight gray scale ranges created by dividing gray scale values ranging from 0 to 255 into eight parts, when input data has a gray scale value of 240, the compensation data generator 113 generates the compensation data as 240, which is a representative value in the eighth gray scale range ranging from 223 to 255, and transfers the compensation data to the driver 130. That is, the compensation data is generated as the representative gray scale value of the corresponding gray scale range, to which the gray scale level of the input data for a calibrated pixel or the test signal belongs, not as individual gray scale values of each individual piece of the input data for calibrated pixels or the test signal, whereby the use of memory may be reduced.

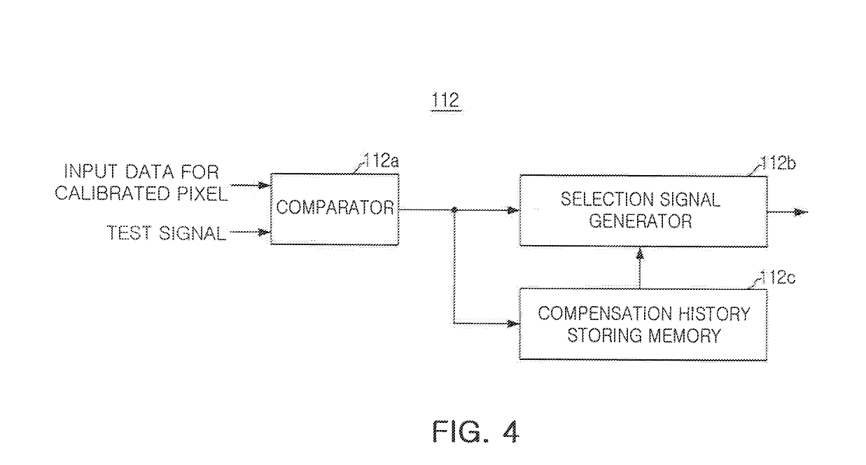

FIG. 4 is a view schematically showing the configuration of a selection signal generator used in the converter of FIG. 2.

Referring to FIG. 4, the selection signal generator 112 used in the converter 110 used in the organic light emitting diode driver 100 according to the exemplary embodiment may include a comparator 112a, a selection signal generator 112b, and a compensation history storing memory 112c.

The comparator 112a may compare the input data for a calibrated pixel with the test signal to determine whether the input data for a calibrated pixel is identical to the test signal.

When the input data for a calibrated pixel is identical to the test signal, the selection signal generator 112b generates a selection signal in order that the compensation data corresponding to the input data for a calibrated pixel is outputted. On the other hand, when the input data for a calibrated pixel is not identical to the test signal, in the case in which there is no compensation history of the input data for a calibrated pixel, the initial data, stored at the operation start time and corresponding to the input data for a calibrated pixel, may be outputted as calibration data, and in the case in which there is the compensation history of the input data for a calibrated pixel, compensation data corresponding to the test signal may be outputted to the driver 130.

The compensation history storing memory 112c may store a compensation history of a corresponding input data.

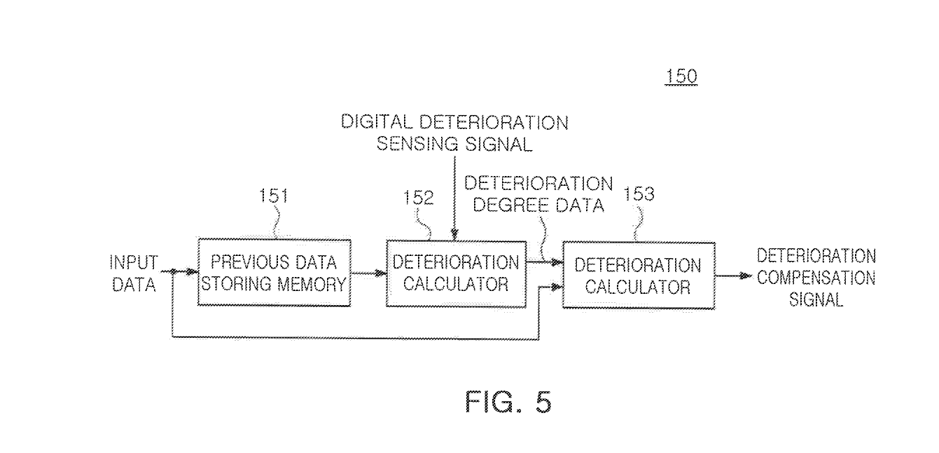

FIG. 5 is a view schematically showing the configuration of a compensator used in an organic light emitting diode driver according to an exemplary embodiment of the present invention.

Referring to FIGS. 1 and 5, the compensator 160 used in the organic light emitting diode driver 100 according to the embodiment of the present invention may include a previous data storing memory 161, a deterioration calculator 162, and a calibration data calculator 163.

The previous data storing memory 161 may store initial luminance data of a target pixel to be compensated or luminance data obtained by the previous compensation. The deterioration calculator 162 may calculate the degree of deterioration of the corresponding pixel by comparing deterioration information of the corresponding pixel with the luminance data from the previous data storing memory 161. The calibration data calculator 163 may calculate calibration data adjusting the luminance of the corresponding pixel according to the degree of deterioration calculated by the deterioration calculator 162 and provide a deterioration compensation signal including the calibration data to the converter 110.

Referring to FIG. 1, the driver 130 may drive pixels of the pixel unit 140 according to the calibration data or the compensation data from the converter 110.

The pixel unit 140 may include a plurality of pixels having a matrix of a plurality of columns and rows, and the pixels may be driven row by row.

The ADC 150 may convert an analog deterioration sensing signal, corresponding to a pixel from the pixel unit 140, into a digital deterioration sensing signal, and transfer the digital deterioration sensing signal to the compensator 160.

The compensator 160 may provide a deterioration compensation signal based on the digital deterioration sensing signal.

The operations of an organic light emitting diode driver according to an exemplary embodiment of the present invention will be described in detail with reference to the accompanying drawings.

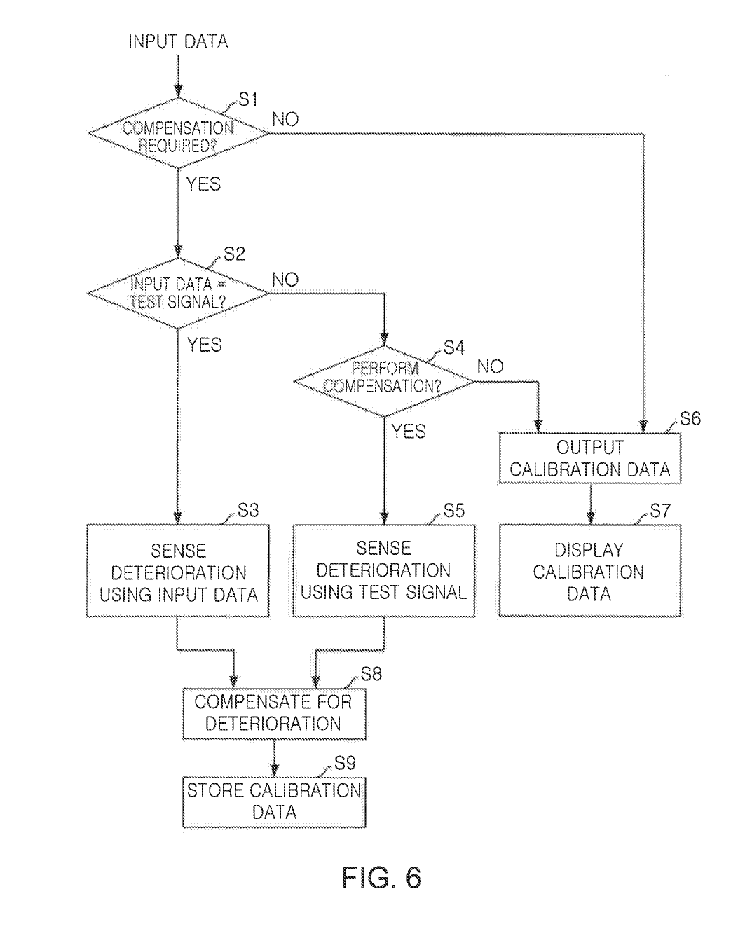

FIG. 6 is a flowchart showing the operations of an organic light emitting diode driver according to an exemplary embodiment of the present invention.

Referring to FIGS. 1 to 6, in the organic light emitting diode driver 100 according to the exemplary embodiment of the present invention, when input data is inputted to drive a pixel, it is determined whether or not the input data has undergone deterioration compensation (S1). That is, when deterioration in the pixel driven by the input data has already been compensated for, the converter 110 transfers calibration data corresponding to the input data to the driver 130 (S6). When deterioration in the pixel driven by the input data needs to be compensated for, the input data is compared with a test signal having preset test data and it is determined whether the input data is identical to the test signal (S2). When the input data is identical to the test signal, the compensation data generator 114 may transfer compensation data corresponding to the input data to the driver 130 according to a selection signal of the selection signal generator 112 (S3). At this time, the compensation data generator 114 may have a plurality of preset gray scale ranges and provide the driver 130 with the compensation data generated as a representative value of a gray scale range to which the gray scale level of the input data belongs.

When the input data is not identical to the test signal, in the case in which there is no compensation history of the input data and the compensation needs to be performed (S4), the selection signal generator 112b provides a selection signal to the compensation data generator 114 such that the compensation data corresponding to the test signal is outputted (S5), while in the case in which there is the compensation history of the input data (S4), initial data stored at an operation start time is outputted as calibration data and the calibration data is transferred to the driver 130 (S6).

The driver 130 drives the pixel of the pixel unit 140 according to the calibration data from the converter 110 (S7) or drives the pixel of the pixel unit 140 according to the compensation data from the converter 110, and the pixel unit 140 detects deterioration in the driven pixel (S8). In addition, the use time of the driven pixel may be measured.

The ADC 150 may convert an analog deterioration sensing signal into a digital deterioration sensing signal, and the compensator 160 may transfer a deterioration compensation signal having calibration data based on the digital deterioration sensing signal to the converter 110 (S8). At this time, the input data may be converted into calibration data according to the degree of deterioration by using initial data or previous compensation data stored in the previous data storing memory 161. In order to more accurately perform the deterioration compensation, the deterioration compensation according to the use time of the driven pixel may also be included in the calibration data.

As set forth above, an organic light emitting diode driver according to exemplary embodiments of the present invention can compensate for pixel deterioration in real time during the driving of pixels by selectively compensating pixels, requiring compensation, for the deterioration thereof according to a test signal without requiring a separate compensation time. In addition, since compensation data is set as a representative tray scale value within a gray scale range, compensation data corresponding to all the gray scale values is not required to be stored, whereby memory size can be reduced.

As set forth above, an organic light emitting diode driver according to exemplary embodiments of the present invention is capable of compensating for pixel deterioration in real time according to whether or not a target pixel to be driven by input data is calibrated and according to the results of comparing the input data with data included in a preset test signal.

While the present invention has been shown and described in connection with the exemplary embodiments, it will be apparent to those skilled in the art that modifications and variations can be made without departing from the spirit and scope of the invention as defined by the appended claims.

What is claimed is:

1. An organic light emitting diode driver comprising:
a converter converting input data into compensation data used to selectively compensate for pixel deterioration according to whether or not the input data has been calibrated and according to a result of comparing the input data with a test signal having preset test data;
a test signal generator providing the test signal;
a driver driving pixels of a pixel unit according to the compensation data from the converter; and
a compensator providing the converter with a deterioration compensation signal according to deterioration information obtained from a pixel driven by the driver.

2. The organic light emitting diode driver of claim 1, wherein the converter stores calibration data included in the deterioration compensation signal from the compensator and converts input data for a non-calibrated pixel into calibration data corresponding thereto,
the converter converts input data for a calibrated pixel into compensation data corresponding thereto when the input data for a calibrated pixel is identical to the test data,
the converter converts input data for a calibrated pixel into compensation data corresponding to the test signal when the input data for a calibrated pixel is different from the test data and the pixel to be driven by the input data for a calibrated pixel is to be compensated for, and
the converter outputs initial data, stored at an operation start time and corresponding to input data for a calibrated pixel, when the input data for a calibrated pixel is different from the test data and the pixel to be driven by the input data for a calibrated pixel is not to be compensated for.

3. The organic light emitting diode driver of claim 2, wherein the converter comprises:
a compensation selector selecting whether to perform compensation according to whether or not the input data has been calibrated;
a selection signal generator generating a selection signal selecting compensation data whether or not the test signal is identical to the input data selected to be compensated for by the compensation selector;
a calibration data storing memory storing the calibration data corresponding to the input data and outputting the calibration data when the input data is determined as input data for a non-calibrated pixel; and
a compensation data generator providing the compensation data corresponding to the input data or the test data according to the selection signal of the selection signal generator.

4. The organic light emitting diode driver of claim 3, wherein the calibration data storing memory further stores the initial data storing luminance data of each pixel at the operation start time.

5. The organic light emitting diode driver of claim 3, wherein the selection signal generator includes:
a comparator comparing whether or not the test signal is identical to the input data for a calibrated pixel selected to be compensated for by the compensation selector;
a selection signal generator generating the selection signal according to the comparison result from the comparator and a compensation history of the input data for a calibrated pixel; and
a compensation history storing memory storing the compensation history of the input data for a calibrated pixel.

6. The organic light emitting diode driver of claim 3, wherein the compensation data generator has a plurality of preset gray scale ranges and provides the compensation data as a representative value of a gray scale range, to which a gray scale level of the input data belongs.

7. The organic light emitting diode driver of claim 1, wherein the compensator comprises:
a previous data storing memory storing initial luminance data of a target pixel to be compensated or luminance data obtained by a previous compensation;
a deterioration calculator calculating a degree of deterioration in the pixel by comparing deterioration information of the pixel with the luminance data from the previous data storing memory; and
a calibration data calculator calculating calibration data adjusting a luminance of the pixel according to the degree of deterioration calculated by the deterioration calculator.

8. The organic light emitting diode driver of claim 7, wherein the calibration data calculator calculates the calibration data adjusting the luminance of the pixel to have a luminance equal to an average luminance of all of the pixels.

9. The organic light emitting diode driver of claim 1, further comprising an analog-to-digital converter (ADC) converting the deterioration information obtained from the driven pixel of the pixel unit into a digital deterioration sensing signal and transferring the digital deterioration sensing signal to the compensator.

10. The organic light emitting diode driver of claim 9, wherein the compensator comprises:
a previous data storing memory storing initial luminance data and use time of a target pixel to be compensated or luminance data and use time thereof obtained by a previous compensation;
a deterioration calculator calculating a degree of deterioration in the pixel by comparing deterioration information of the pixel with the luminance data and the use time thereof from the previous data storing memory; and
a calibration data calculator calculating calibration data adjusting a luminance of the pixel according to the degree of deterioration calculated by the deterioration calculator.

11. The organic light emitting diode driver of claim 10, wherein the calibration data calculator calculates the calibration data adjusting the luminance of the pixel to have a luminance equal to an average luminance of all of the pixels.
